(19) United States
(12) Patent Application Publication
(10) Pub. No.: US 2005/0060345 A1
(43) Pub. Date: Mar. 17, 2005

(54) Methods and systems for using XML schemas to identify and categorize documents

(76) Inventor: Andrew Doddington, London (GB)

Correspondence Address: DOCKET ADMINISTRATOR;LOWENSTEIN SANDLER PC, 65 LIVINGSTON AVENUE, ROSELAND, NJ, 07068, US

(21) Appl. No.: 10/697,501

(22) Filed: Oct. 30, 2003

Related U.S. Application Data
(60) Provisional application No. 60/502,129, filed on Sep. 11, 2003.

(51) Int. Cl. G06F 17/00

(52) U.S. Cl. 707/103 Y

(57) ABSTRACT

A method for identifying an XML document includes the steps of obtaining the document, matching the document against a plurality of XML schemas that specify a set of document types that support a particular application, and, based on the results of these comparisons, outputting information regarding the document type. The outputted information could include information regarding the identity of the document type. Furthermore, in the event that the document fails to match the schemas exactly, the document type which most closely matches the given document could be identified. In this case, a match score for the closest document might also be returned. A match score of zero could indicate a perfect match and any positive value a mismatch, with the score value increasing with the degree of mismatch, for example.

### CROSS REFERENCE TO RELATED APPLICATIONS

This application claims the benefit of U.S. Provisional Application Ser. No. 60/502,129, filed by Andrew Doddington on Sep. 11, 2003 and entitled “Methods and Systems For Using XML Schemas to Identify and Categorize Documents”, which is incorporated herein by reference.

### FILED OF THE INVENTION

The present invention relates generally to document processing and, more particularly, to methods and systems for using XML schemas to identify and categorize documents.

### BACKGROUND OF THE INVENTION

In an effort to deal with data interchange issues, the World Wide Web Consortium (W3C) has created the Extensible Markup Language (XML). W3C is the standards group responsible for maintaining and advancing HTML and other Web-related standards.

To a large extent, W3C's work on the XML project has been very successful. Most major software vendors now support XML, and its usage is becoming widespread. Because XML data is stored in plain text, XML provides a software- and hardware-independent way of sharing data. This allows different applications to work with the data. Converting data to XML allows data to be exchanged by many different types of applications and platforms.

According to the current W3C standard, an XML document must have a correct syntax and may optionally be defined as conforming to an XML schema. An XML schema describes the structure of an XML document and is generally used by applications to confirm that the document is correct, before any further processing is performed.

### SUMMARY OF THE INVENTION

A method for identifying an XML document includes the steps of obtaining the document, matching the document against a plurality of XML schemas that specify a set of document types that are supported by a particular application, and, based on the results of these comparisons, outputting information regarding the document type. The outputted information could include information regarding the identity of the document type. Furthermore, in the event that the document fails to match the schemas exactly, the document type which most closely matches the given document could be identified. In this case, a match score for the closest document might also be returned. A match score of zero might indicate a perfect match and any positive value a mismatch, with the score value increasing with the degree of mismatch, for example. In various embodiments, the present invention can allow selection between alternative document types, based on the match score obtained for each type, as represented by its corresponding schema.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 illustrates an exemplary Validation Engine for identifying an XML document that passes an XML document and its associated schema to a Validation Routine, which then returns a pass/fail indicator;

FIG. 2 illustrates an exemplary usage in which a single document is validated against a plurality of XML schemas, obtaining a match indicator for each such comparison; and

FIG. 3 illustrates an alternate embodiment of the Validation Routine in which a match score is returned.

### DESCRIPTION OF PREFERRED EMBODIMENTS

XML schemas provide a formalized technique for describing the structure of XML documents. An XML schema defines the attributes of an XML document, the order and number of the child elements, data types of the elements and the attributes, and various default and fixed values for the elements and the attributes. XML schemas essentially consider two fundamental types of element. The first type is a Simple Type, in which the element does not contain any child elements, but instead contains text content. This is demonstrated in the example below, which shows an Simple Type element called “Age”, containing the integer value “21”:
<Age>21</Age>

The other type of element recognized by schemas is termed a Complex Type, in which the element contains one or more child elements. As an example, the Person element shown below has a Complex Type, since it contains the child elements “Name” and “Age” (which are themselves simple types):

<Person>

<Name>John Doe</Name>
<Age>21</Age>

</Person>

An XML schema allows a given XML document to be validated to confirm whether or not it adheres to the schema. Besides this conventional usage, several alternatives uses for XML schemas are possible.

In various exemplary embodiments of the present invention, a list of XML schemas is maintained which correspond to the set of document types that a given application is able to recognize. A given document can then be validated against each of the schemas, to identify the document type.

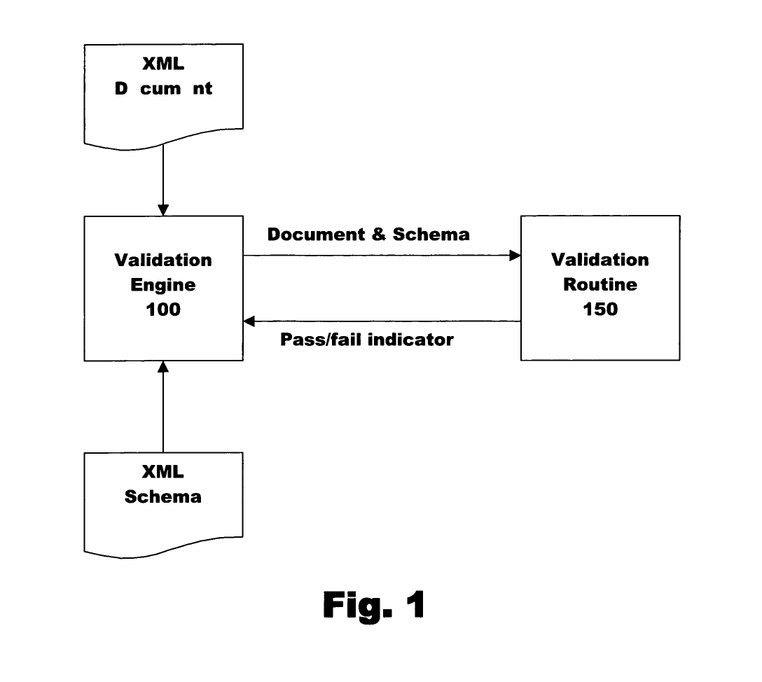

FIG. 1 shows an exemplary Validation Engine 100 for identifying a document type. The Validation Engine 100 invokes instances of a Validation Routine 150 which returns a pass/fail indicator, depending on whether or not the document matches the schema.

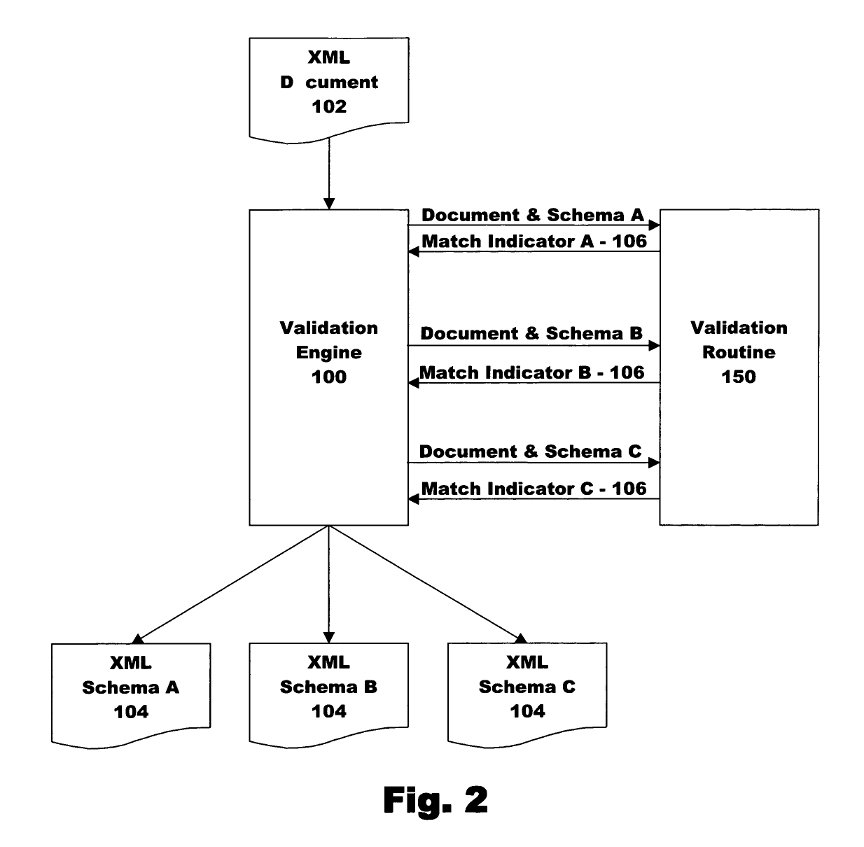

FIG. 2 shows an exemplary enhancement to the previous case in which the Validation Engine 100 invokes an instance Validation Routine 150 for each of the schemas 104 in a list of Schemas associated with a particular application.

As an example, consider an XML document of an unknown type received by the U.S. Patent and Trademark Office. Let us assume that the document could only be (1) a patent application, (2) a trademark application, or (3) a petition. Assuming that XML schemas exist for each of these document types, the incoming document would be matched against each of the schemas to determine the document type. In this example, the Validation Engine 100 would make three calls to the Validation Routine 150. Each call would pass a copy of the document (or a reference to it) along with one of the schemas (or a reference to it). Each time it is called, the Validation Routine 150 returns a match indicator. (This match indicator could be a Boolean “True” or “False” data type).

The Validation Engine 100 determines the document type using all of the returned match indicators 106. For example, if the Validation Engine 100 received a “True” value corresponding to the XML schema for a “patent application”, a “False” value corresponding to the XML schema for a “trademark application”, and a “False” value corresponding to the XML schema for a “petition”, the Validation Engine 100 would thereby conclude that the document is a patent application. The Validation Engine 100 would then return this as an indication that the document is a patent application.

Note that in the interests of efficiency, the process would probably terminate on the first “True” match, since most documents should only be capable of matching a single schema.

Some situations under which this document categorization process may be performed include: (1) an application which receives various documents from external applications and which needs to perform this categorization process before performing further operations on the document; and (2) an application which processes a single document that is undergoing incremental change, e.g., as a result of user interaction using a document editor. In this case, only one document is under consideration, but its shape and form are under frequent change.

The document categorization process described herein can also be used to: (1) determine the document type to identify subsequent software systems to which the document should be sent, i.e., to act as a basis for routing the document; (2) indicate what further forms of validation may be performed against the document—taking this selection process as a first level of validation, where the second-level validation is only justified once the document has passed the first level. This may be due to a number of factors, including: the potential overhead of the second level validation, or concern that this second level validation might generate an excessive number of errors if it is performed against an inappropriate document, etc. (3) provide feedback to an interactive user, to confirm that the document that they are entering has been recognized and that it conforms to a known document structure. This may also be used to control which further functionality is available to the user, since some operations may only be applicable to certain document types. It is to be appreciated that these examples are only illustrative, and that many other applications may be identified that make use of this mechanism.

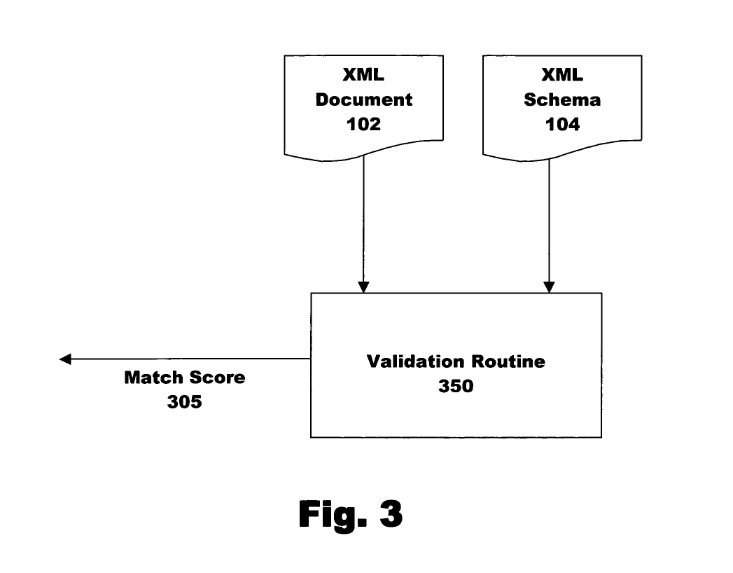

As mentioned, existing schema-based validation facilities generally restrict themselves to simply indicating whether or not a given document matches a given schema. In another embodiment of the present invention, rather than providing a simple pass/fail indicator, the Validation Routine returns a match score that indicates the degree to which a given document matches a schema. For example, a match score of zero could indicate a perfect match and any positive value a mismatch, with the score value increasing with the degree of mismatch. FIG. 3 illustrates an exemplary Validation Routine 350 being passed the XML document 102 and the XML schema 104, and returning a match score 305. This Validation Routine 350 could be incorporated into a Validation Engine to select the most closely matched document (e.g., the schema returning the lowest score).

The match score could be produced by summing mismatch scores. As discussed, when an XML document is matched against a schema, it might be determined that certain aspects of the XML document fail to conform to the schema. Depending on the particular mismatch situation, a particular mismatch score can be calculated. In general, a higher score will be calculated for mismatches that are more important. As an example, a mismatch on a simple data value might contribute a score of “1”, while a missing mandatory complex data type element might contribute a score of “20”. By considering the simple and complex data types described previously, an example of a simple data value mismatch might be an “Age” element, which is indicated in the schema as containing an integer value, being found to hold an alphabetic value. By contrast, a missing complex data type could occur in the case where a schema indicates that a “Person” element is mandatory at a particular point in the document but is not present in the document that is being tested.

It is to be appreciated that the exact weighting of the mismatch scores may require to be adjusted over time to improve the accuracy in selecting the most appropriate schema. As an example, over time, it might be found that the scores of “1” and “20” given above might be more suitably set to “5” and '15”, respectively. This would indicate that three “simple” data errors were equivalent to a single “complex” data error (since three of the “5” scores will produce the identical arithmetic result as a single “15” score).

Advantageously, the present invention will preferably employ a minimum mismatch technique. The term minimum mismatch is intended to convey the notion that multiple, potential matches may exist between an invalid document and a schema, depending on how the different parts of the document are taken to relate to the different parts of the schema. Alternatively, this may be viewed as the minimum number of edit operations that would need to be applied to the document in order to make it conform to the schema. As an example, a schema might define a complex data type as containing the sequence of child elements:
A-B-C-D
   To be read as “an ‘A’ element followed by a ‘B’ element, followed by a ‘C’ element, followed by a ‘D’ element”.
   In contrast to this, the document being tested might contain the actual sequence:
A-C-D.
   That is, an “A” element, followed by a “C” element, followed by a “D” element. One view might to be record this as three errors in total, comprising two mismatches (i.e., B to C and C to D), together with a completely missing “D” element. However, a more accurate (and minimal) view would be to base the score on the single error that the “B” element was omitted. This leads to a score based on a single error, rather than the three errors produced by the previous approach.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

1. A method for identifying an XML document, comprising the steps of:
obtaining a document;
matching the document against a plurality of XML schemas that specify a set of document types; and
based on the result of the matching step, outputting information regarding the document.

2. The method of claim 1, wherein the outputted information includes information regarding the identity of the document type.

3. The method of claim 1, wherein the matching step includes determining match scores.

4. The method of claim 3, wherein each of the match scores reflects the degree of closeness between the document and one of the XML schemas.

5. The method of claim 4, wherein a match score of zero indicates a perfect match.

6. The method of claim 4, wherein a non-zero match score indicates a mismatch.

7. The method of claim 3, wherein determining the match scores includes determining the match scores by performing minimum-mismatch comparisons.

8. The method of claim 1, wherein the document is received from an external source.

9. The method of claim 8, wherein the external source uses the outputted information to perform a categorization process before performing further operations on the document.

10. The method of claim 8, wherein the external source uses the outputted information to route the document.

11. The method of claim 8, wherein the external source uses the outputted information to determine whether the document passes a first-level validation.

12. The method of claim 1, wherein the document is undergoing incremental change.

13. The method of claim 1, wherein the outputted information includes confirmation that the document conforms to a known document structure.

14. A system for identifying an XML document, comprising:
an input component for obtaining a document;
a validation component for matching the document against a plurality of XML schemas that specify a set of document types; and
an output component for outputting information regarding the document indicating the results of the matching.

15. The system of claim 14, wherein the outputted information includes information regarding the identity of the document type.

16. The system of claim 14, wherein the validation component determines match scores.

17. The system of claim 16, wherein each of the match scores reflects the degree of closeness between the document and one of the XML schemas.

18. The system of claim 17, wherein a match score of zero indicates a perfect match.

19. The system of claim 17, wherein a non-zero match score indicates a mismatch.

20. The system of claim 16, wherein the validation component determines the match scores by performing minimum-mismatch comparisons.

21. The system of claim 14, wherein the input component receives the document from an external source.

22. The system of claim 21, wherein the external source uses the outputted information to perform a categorization process before performing further operations on the document.

23. The system of claim 21, wherein the external source uses the outputted information to route the document.

24. The system of claim 21, wherein the external source uses the outputted information to determine whether the document passes a first-level validation.

25. The system of claim 14, wherein the document is undergoing incremental change.

26. The system of claim 14, wherein the outputted information includes confirmation that the document conforms to a known document structure.

27. A program storage device readable by a machine, tangibly embodying a program of instructions executable on the machine to perform method steps for identifying an XML document, the method steps comprising:
obtaining a document;
matching the document against a plurality of XML schemas that specify a set of document types; and
based on the result of the matching step, outputting information regarding the document.
